(19) United States
(12) Patent Application Publication
(10) Pub. No.: US 2020/0030956 A1
(43) Pub. Date: Jan. 30, 2020

(54) Heatsink Structure for Pile Driver

(71) Applicant: Chuan-Shan Huang, Changhua City (TW)

(72) Inventor: Chuan-Shan Huang, Changhua City (TW)

(21) Appl. No.: 16/048,407

(22) Filed: Jul. 30, 2018

(51) Int. Cl. B25D 17/20; F16H 1/20; F16H 57/038; F16H 57/021; B25D 9/12

(52) U.S. Cl. CPC B25D 17/20; F16H 1/203; F16H 57/038; F16H 57/021; B25D 2250/331; B25D 2217/0061; B25D 2217/0096; B25D 2250/125; B25D 9/12

(57) ABSTRACT

A heatsink structure for a pile driver includes a rotation seat, a pivot base, a pile driver gear unit, and at least one radiating pipe. The rotation seat is pivotally connected with the pivot base. The pile driver gear unit is mounted in the pivot base and includes a receiving space and a vibration device. A pump device is mounted in the receiving space of the pile driver gear unit. The at least one radiating pipe is mounted on the pivot base. Thus, the lubricating oil in the receiving space of the pile driver gear unit is pumped by the pump device during operation and is delivered to the at least one radiating pipe so that the at least one radiating pipe cools down and carries away the heat of the lubricating oil.

### BACKGROUND OF THE INVENTION

### 1. Field of the Invention

The present invention relates to a heatsink structure and, more particularly, to a heatsink structure for a pile driver.

### 2. Description of the Related Art

A conventional pile driver comprises a hammer, a pile, and a crane. The hammer is suspended by a hanging hook and driven by the crane to drop and hit the pile so as to move the pile into the earth gradually. The conventional pile driver is driven by a power that comes from the hydraulic pressure to reduce noise and vibration. The liquid used by the conventional pile driver is a synthetic oil with a lubricating function. However, the heat energy produced during operation of the conventional pile driver cannot be drained easily so that the temperature of the synthetic oil rises gradually, and the synthetic oil easily deteriorates or fails and loses its lubricating function, thereby rendering wear of the tools of the pile driver. In addition, the bearings of the pile driver are easily expanded and distorted due to the high temperature, thereby failing the pile driver.

### BRIEF SUMMARY OF THE INVENTION

The primary objective of the present invention is to provide a heatsink structure having a quick heat dissipating effect.

In accordance with the present invention, there is provided a heatsink structure comprising a rotation seat, a pivot base, a pile driver gear unit, and at least one radiating pipe. The rotation seat is pivotally connected with the pivot base. The pivot base is provided with a mounting section. The pile driver gear unit is mounted in the mounting section of the pivot base and includes a receiving space and a vibration device. The vibration device includes two drive shafts. The pile driver gear unit includes an inlet hole and an outlet hole. The inlet hole of the pile driver gear unit is connected to the receiving space. A pump device is mounted in the receiving space of the pile driver gear unit and includes an inlet port, an outlet port, a receiving recess, a rotation shaft, a through hole, a driven member and at least one guiding member. The inlet port of the pump device is connected to the receiving space of the pile driver gear unit and connected to the receiving recess. The outlet port of the pump device is connected to the outlet hole of the pile driver gear unit and connected to the receiving recess. The rotation shaft of the pump device is pivotally mounted in the through hole. The at least one guiding member of the pump device is mounted in the receiving recess and connected with a lower end of the rotation shaft. The driven member of the pump device is connected with an upper end of the rotation shaft. The vibration device includes a driving member mounted on one of the two drive shafts and engaging the driven member of the pump device. The at least one radiating pipe is mounted on the pivot base and includes a heat radiating hole having an inlet terminal and an outlet terminal The at least one radiating pipe is made of heat conductive material. The heat radiating hole extends through the at least one radiating pipe, with the at least one radiating pipe having a hollow shape. The inlet terminal of the at least one radiating pipe is connected to the outlet hole of the pile driver gear unit, and the outlet terminal of the at least one radiating pipe is connected to the inlet hole of the pile driver gear unit. One of the two drive shafts drives the driving member which drives the driven member which drives the rotation shaft which drives the at least one guiding member. When one of the two drive shafts is rotated, the rotation shaft and the at least one guiding member are rotated, so that a liquid contained in the receiving space of the pile driver gear unit in turn flows through the inlet port of the pump device, the receiving recess of the pump device and the outlet port of the pump device into the outlet hole of the pile driver gear unit. The liquid is drained out of the outlet hole of the pile driver gear unit and is introduced through the inlet terminal into the heat radiating hole of the at least one radiating pipe and flows outward from the outlet terminal of the at least one radiating pipe. The liquid is drained out of the outlet terminal of the at least one radiating pipe and is introduced through the inlet hole into the receiving space of the pile driver gear unit.

According to the primary advantage of the present invention, the lubricating oil is pumped by the pump device during operation and is delivered to the at least one radiating pipe so that the at least one radiating pipe cools down and carries away the heat of the lubricating oil, to provide a quick heat dissipating effect.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a perspective view of a heatsink structure for a pile driver in accordance with the preferred embodiment of the present invention.

FIG. 2 is an exploded perspective view of the heatsink structure for a pile driver in accordance with the preferred embodiment of the present invention.

FIG. 3 is a block diagram showing a conducting state of the heatsink structure for a pile driver in accordance with the preferred embodiment of the present invention.

FIG. 4 is an enlarged bottom view of the heatsink structure for a pile driver in accordance with the preferred embodiment of the present invention.

FIG. 5 is a schematic front view showing the heatsink structure for a pile driver in use.

### DETAILED DESCRIPTION OF THE INVENTION

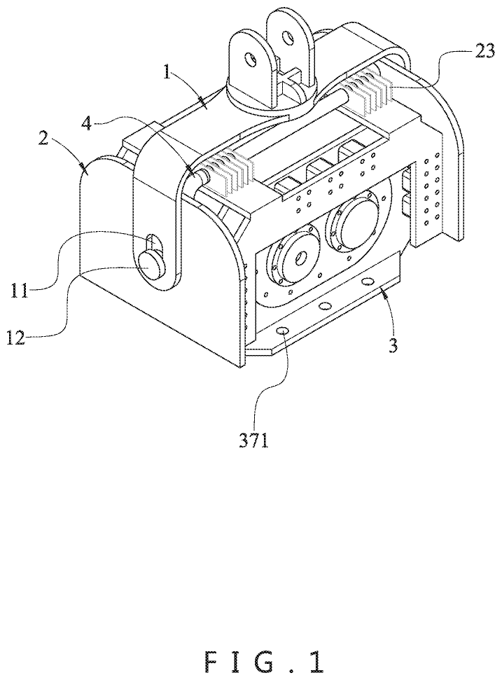

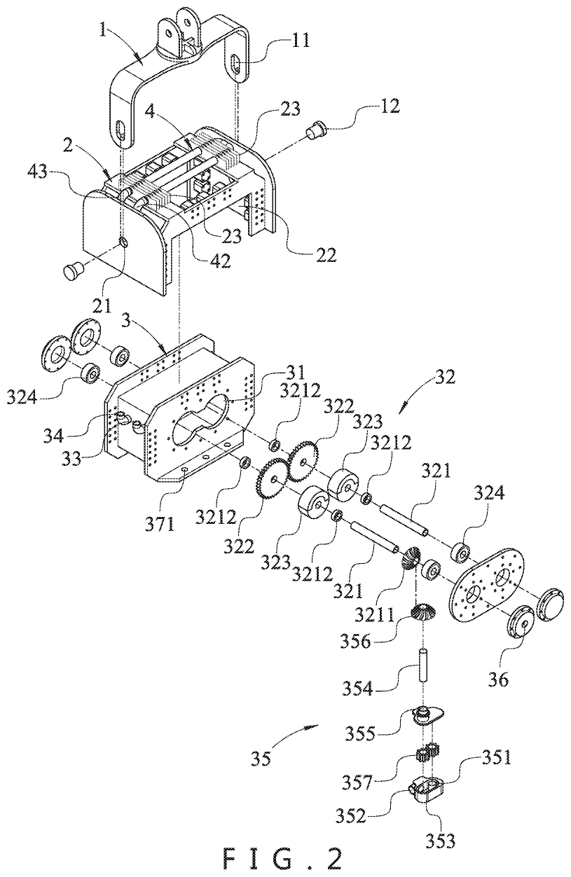

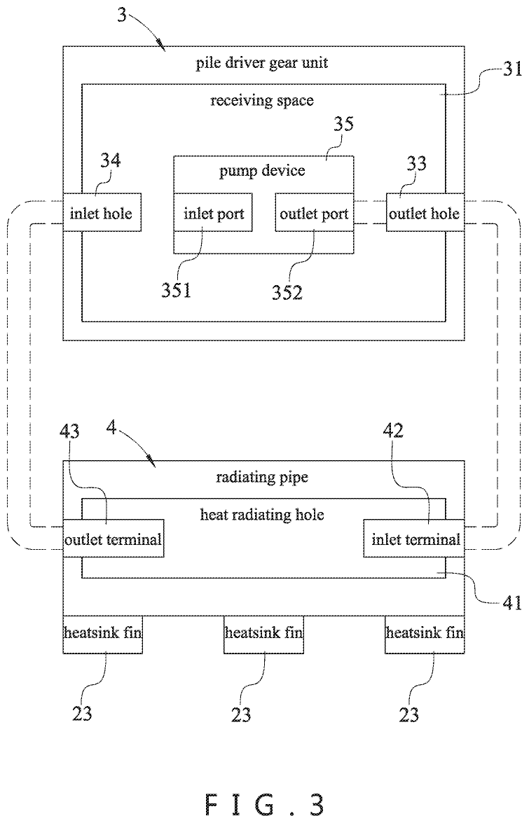

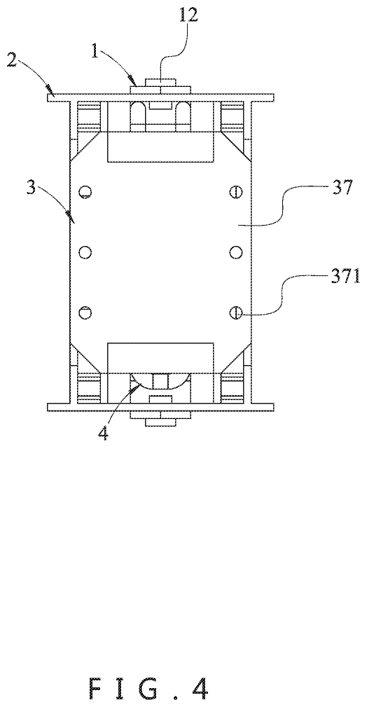

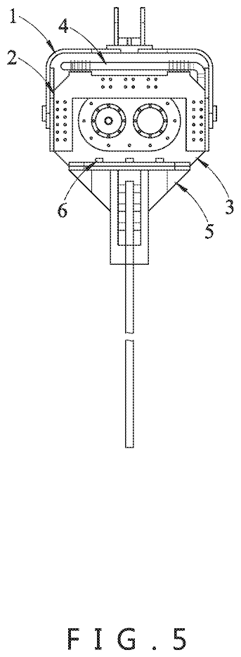

Referring to FIGS. 1-5, a heatsink structure for a pile driver in accordance with the preferred embodiment of the present invention comprises a rotation seat 1, a pivot base 2, a pile driver gear unit 3, and at least one radiating pipe 4. The rotation seat 1 has two pivot holes 11 formed in two opposite sides thereof. The pivot base 2 is provided with two pivot portions 21 corresponding to the two pivot holes 11 of the rotation seat 1, and two pivot members 12 extend through the two pivot holes 11 of the rotation seat 1 and the two pivot portions 21 of the pivot base 2, so that the rotation seat 1 is pivotally connected with the pivot base 2. The pivot base 2 is provided with a mounting section 22. The pile driver gear unit 3 is mounted in the mounting section 22 of the pivot base 2 and includes a receiving space 31 and a vibration device 32. The vibration device 32 includes two drive shafts 321.

The characteristic of the present invention is in that, the pile driver gear unit 3 includes an inlet hole 34 and an outlet hole 33. The inlet hole 34 of the pile driver gear unit 3 is connected to the receiving space 31. A pump device 35 is mounted in the receiving space 31 of the pile driver gear unit 3 and includes an inlet port 351, an outlet port 352, a receiving recess 353, a rotation shaft 354, a through hole 355, a driven member 356 and at least one guiding member 357. The inlet port 351 of the pump device 35 is connected to the receiving space 31 of the pile driver gear unit 3 and connected to the receiving recess 353. The outlet port 352 of the pump device 35 is connected to the outlet hole 33 of the pile driver gear unit 3 and connected to the receiving recess 353. The rotation shaft 354 of the pump device 35 extends through and is pivotally mounted in the through hole 355. The at least one guiding member 357 of the pump device 35 is mounted in the receiving recess 353 and connected with a lower end of the rotation shaft 354. The driven member 356 of the pump device 35 is connected with an upper end of the rotation shaft 354. The vibration device 32 includes a driving member 3211 mounted on one of the two drive shafts 321 and engaging the driven member 356 of the pump device 35.

In practice, one of the two drive shafts 321 drives the driving member 3211 which drives the driven member 356 which drives the rotation shaft 354 which drives the at least one guiding member 357. In such a manner, when one of the two drive shafts 321 is rotated, the rotation shaft 354 and the at least one guiding member 357 are rotated, so that a liquid (such as a lubricating oil) contained in the receiving space 31 of the pile driver gear unit 3 in turn flows through the inlet port 351 of the pump device 35, the receiving recess 353 of the pump device 35 and the outlet port 352 of the pump device 35 into the outlet hole 33 of the pile driver gear unit 3.

The at least one radiating pipe 4 is mounted on the pivot base 2 and includes a heat radiating hole 41 having an inlet terminal 42 and an outlet terminal 43. The at least one radiating pipe 4 is made of heat conductive material. The heat radiating hole 41 extends through a whole length of the at least one radiating pipe 4 so that the at least one radiating pipe 4 has a hollow shape. The inlet terminal 42 of the at least one radiating pipe 4 is connected to the outlet hole 33 of the pile driver gear unit 3, and the outlet terminal 43 of the at least one radiating pipe 4 is connected to the inlet hole 34 of the pile driver gear unit 3.

In practice, the liquid (or the lubricating oil) is drained out of the outlet hole 33 of the pile driver gear unit 3 and is introduced through the inlet terminal 42 into the heat radiating hole 41 of the at least one radiating pipe 4 and flows outward from the outlet terminal 43 of the at least one radiating pipe 4. In such a manner, when the liquid flows through the heat radiating hole 41 of the at least one radiating pipe 4, the at least one radiating pipe 4 provides a heat dissipating effect to cool down and reduce the temperature of the liquid. Then, the liquid (or the lubricating oil) is drained out of the outlet terminal 43 of the at least one radiating pipe 4 and is introduced through the inlet hole 34 into the receiving space 31 of the pile driver gear unit 3. Thus, the hot liquid is drained out of the receiving space 31 of the pile driver gear unit 3, and the cooled liquid is introduced into the receiving space 31 of the pile driver gear unit 3, so that the liquid is circulated in the receiving space 31 of the pile driver gear unit 3 to efficiently drain the heat energy contained in the pile driver gear unit 3.

In the preferred embodiment of the present invention, the vibration device 32 includes two gears 322 mounted on the two drive shafts 321 and meshing with each other, and two vibrators 323 mounted on the two drive shafts 321 and abutting the two gears 322. The two vibrators 323 are rotated by the two drive shafts 321 and produce vibration.

In the preferred embodiment of the present invention, the vibration device 32 includes a plurality of positioning members 3212 mounted on the two drive shafts 321 and abutting the two gears 322 and the two vibrators 323, with the two gears 322 and the two vibrators 323 being located between the positioning members 3212.

In the preferred embodiment of the present invention, the vibration device 32 includes a plurality of bearings 324 pivotally mounted on the two drive shafts 321 and located in the receiving space 31 of the pile driver gear unit 3.

In practice, the heat of the lubricating oil is dissipated by the at least one radiating pipe 4. Then, the lubricating oil is drained out of the outlet terminal 43 of the at least one radiating pipe 4 and is introduced through the inlet hole 34 into the receiving space 31 of the pile driver gear unit 3, so that the bearings 324 are immersed in the lubricating oil which cools down the bearings 324. In such a manner, the bearings 324 are operated at a predetermined temperature, so that the bearings 324 will not be expanded and deformed due to an excessive heat and are operated at a normal state, thereby enhancing the lifetime of the vibration device 32.

In the preferred embodiment of the present invention, the pile driver gear unit 3 includes a passage 36, and one of the two drive shafts 321 extends through the passage 36 and is connected to and driven by an external power source. In practice, the two gears 322 mesh with each other, so that the two drive shafts 321 are rotated in concert with each other. Thus, when one of the two drive shafts 321 is rotated by the external power source, the two drive shafts 321 are rotated simultaneously.

In the preferred embodiment of the present invention, the pivot base 2 is provided with a plurality of heatsink fins 23 secured on the at least one radiating pipe 4. Each of the heatsink fins 23 is made of heat conductive material. The at least one radiating pipe 4 transmits a heat energy to the heatsink fins 23 to enhance the heat dissipating effect.

In the preferred embodiment of the present invention, the pivot base 2 includes a thermal grease applied between the heatsink fins 23 to increase the contact area between the at least one radiating pipe 4 and the heatsink fins 23 to enhance the heat conducting effect. The thermal grease is made of silicone, polyurethane, acrylate or hot melt adhesive mixed with metal powder.

In the preferred embodiment of the present invention, the pile driver gear unit 3 and the pivot base 2 are made of metallic material to carry away heat of the liquid in the receiving space 31 of the pile driver gear unit 3.

In the preferred embodiment of the present invention, the pile driver gear unit 3 has a lower end provided with a fitting face 37 which is provided with a plurality of fitting holes 371.

In the preferred embodiment of the present invention, a pile driving device 5 is mounted on the fitting face 37 of the pile driver gear unit 3 by a plurality of threaded fasteners 6 which extend through the fitting holes 371 of the fitting face 37 and are screwed into an upper end of the pile driving device 5 to attach the upper end of the pile driving device 5 to the pile driver gear unit 3.

In the preferred embodiment of the present invention, the driving member 3211 of the vibration device 32 is a bevel gear, the driven member 356 of the pump device 35 is a bevel gear, and the at least one guiding member 357 of the pump device 35 is a gear.

Accordingly, the lubricating oil is pumped by the pump device 35 during operation and is delivered to the at least one radiating pipe 4 so that the at least one radiating pipe 4 cools down and carries away the heat of the lubricating oil, to provide a quick heat dissipating effect. In addition, the at least one radiating pipe 4 transmits a heat energy to the heatsink fins 23 to enhance the heat dissipating effect. Further, the bearings 324 are operated at a predetermined working temperature by the lubricating oil that is cooled, so that the bearings 324 will not be expanded and deformed due to an excessive heat and are operated at a normal state, thereby enhancing the lifetime of the vibration device 32.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the scope of the invention.

1. A heatsink structure comprising:
a rotation seat, a pivot base, a pile driver gear unit, and at least one radiating pipe;
wherein:
the rotation seat is pivotally connected with the pivot base;
the pivot base is provided with a mounting section;
the pile driver gear unit is mounted in the mounting section of the pivot base and includes a receiving space and a vibration device;
the vibration device includes two drive shafts;
the pile driver gear unit includes an inlet hole and an outlet hole;
the inlet hole of the pile driver gear unit is connected to the receiving space;
a pump device is mounted in the receiving space of the pile driver gear unit and includes an inlet port, an outlet port, a receiving recess, a rotation shaft, a through hole, a driven member and at least one guiding member;
the inlet port of the pump device is connected to the receiving space of the pile driver gear unit and connected to the receiving recess;
the outlet port of the pump device is connected to the outlet hole of the pile driver gear unit and connected to the receiving recess;
the rotation shaft of the pump device is pivotally mounted in the through hole;
the at least one guiding member of the pump device is mounted in the receiving recess and connected with a lower end of the rotation shaft;
the driven member of the pump device is connected with an upper end of the rotation shaft;
the vibration device includes a driving member mounted on one of the two drive shafts and engaging the driven member of the pump device;
the at least one radiating pipe is mounted on the pivot base and includes a heat radiating hole having an inlet terminal and an outlet terminal;
the at least one radiating pipe is made of heat conductive material;
the heat radiating hole extends through the at least one radiating pipe, with the at least one radiating pipe having a hollow shape;
the inlet terminal of the at least one radiating pipe is connected to the outlet hole of the pile driver gear unit;
the outlet terminal of the at least one radiating pipe is connected to the inlet hole of the pile driver gear unit;
one of the two drive shafts drives the driving member which drives the driven member which drives the rotation shaft which drives the at least one guiding member;
when one of the two drive shafts is rotated, the rotation shaft and the at least one guiding member are rotated, so that a liquid contained in the receiving space of the pile driver gear unit in turn flows through the inlet port of the pump device, the receiving recess of the pump device and the outlet port of the pump device into the outlet hole of the pile driver gear unit;
the liquid is drained out of the outlet hole of the pile driver gear unit and is introduced through the inlet terminal into the heat radiating hole of the at least one radiating pipe and flows outward from the outlet terminal of the at least one radiating pipe; and
the liquid is drained out of the outlet terminal of the at least one radiating pipe and is introduced through the inlet hole into the receiving space of the pile driver gear unit.

2. The heatsink structure of claim 1, wherein:
the vibration device includes two gears mounted on the two drive shafts and meshing with each other, and two vibrators mounted on the two drive shafts and abutting the two gears; and
the two vibrators are rotated by the two drive shafts and produce vibration.

3. The heatsink structure of claim 2, wherein the vibration device includes a plurality of positioning members mounted on the two drive shafts and abutting the two gears and the two vibrators, with the two gears and the two vibrators being located between the positioning members.

4. The heatsink structure of claim 2, wherein the vibration device includes a plurality of bearings pivotally mounted on the two drive shafts and located in the receiving space of the pile driver gear unit.

5. The heatsink structure of claim 1, wherein the pile driver gear unit includes a passage, and one of the two drive shafts extends through the passage and is connected to and driven by an external power source.

6. The heatsink structure of claim 1, wherein the pivot base is provided with a plurality of heatsink fins secured on the at least one radiating pipe, and each of the heatsink fins is made of heat conductive material.

7. The heatsink structure of claim 6, wherein the pivot base includes a thermal grease applied between the heatsink fins, and the thermal grease is made of silicone, polyurethane, acrylate or hot melt adhesive mixed with metal powder.

8. The heatsink structure of claim 1, wherein the pile driver gear unit and the pivot base are made of metallic material to carry away heat of the liquid in the receiving space of the pile driver gear unit.

9. The heatsink structure of claim 1, wherein the pile driver gear unit has a lower end provided with a fitting face which is provided with a plurality of fitting holes.

10. The heatsink structure of claim 9, further comprising:
a pile driving device mounted on the fitting face of the pile driver gear unit by a plurality of threaded fasteners which extend through the fitting holes of the fitting face and are screwed into an upper end of the pile driving device.
